(19) United States
(12) Patent Application Publication
(10) Pub. No.: US 2024/0424428 A1
(43) Pub. Date: Dec. 26, 2024

(54) METHOD AND SYSTEM FOR TREATMENT OF LIQUID MATERIAL TO RECOVER A GASEOUS EFFLUENT

(71) Applicant: NUIONIC TECHNOLOGIES (CANADA) INC., Fredericton (CA)

(72) Inventors: James M. TRANQUILLA, Fredericton (CA); Kenneth G CLARK, Fredericton (CA)

(21) Appl. No.: 18/687,288

(22) PCT Filed: Aug. 26, 2022
(86) PCT No.: PCT/CA2022/051297

§ 371 Date: Feb. 27, 2024

Related U.S. Application Data
(60) Provisional application No. 63/237,936, filed on Aug. 27, 2021.
(60) Provisional application No. 63/241,720, filed on Sep. 8, 2021.

(51) Int. Cl. B01D 19/00; B01D 53/14; B01D 53/62; B01D 53/78; B01D 53/96; H05B 6/80

(52) U.S. Cl. CPC B01D 19/0084; B01D 19/0078; B01D 53/1425; B01D 53/1475; B01D 53/1493; B01D 53/62; B01D 53/78; B01D 53/96; H05B 6/802; B01D 2252/20405; B01D 2252/20421; B01D 2252/20484; B01D 2257/504; B01D 2259/806; B01D 2259/816

(57) ABSTRACT

Methods and systems for treating a liquid material. A liquid is emplaced in a treatment zone: microwave energy and ultrasonic energy are collectively applied to the treatment zone to effect release of a gaseous material from the liquid material.

### RELATED APPLICATIONS

This application claims the benefit of and priority to: (1) U.S. Provisional Patent Application No. 63/237,936 filed Aug. 27, 2021 entitled “Microwave-stimulated Treatment of Liquid Material”, the contents of which are incorporated herein by reference; and (2) U.S. Provisional Patent Application No. 63/241,720 filed Sep. 8, 2021 entitled “Methods Of Regenerating A Scrubbing Agent Used For Scrubbing A Gaseous Effluent, And Recovering The Scrubbed Gaseous Effluent”, the contents of which are incorporated herein by reference.

### FIELD

This disclosure is directed to methods and systems for treatment of liquid material to recover a gaseous effluent that can be applied, for example, for regenerating a scrubbing agent used for scrubbing the gaseous effluent, and recovering the scrubbed gaseous effluent

### BACKGROUND

The treatment of liquid material to remove a gaseous effluent from the liquid material has many applications in industrial applications. For example, carbon dioxide is a gaseous effluent that is one of the most persistent greenhouse gases because it is a product of every industrial combustion process that uses hydrocarbon fuel sources. The capture and containment of carbon dioxide is, therefore, one of the greatest challenges facing modern industry.

One method of carbon dioxide capture is amine absorption. In this closed circuit process, carbon dioxide gas (for example, flue gas containing carbon dioxide) is brought into contact with an absorbent liquid (for example an amine solution such as monoethanolamine, or MEA) during a “loading” part of the circuit where part of the carbon dioxide is dissolved in the liquid and part of it becomes chemically bonded. This “loaded” liquid is then pumped to a “stripping” part of the circuit where the carbon dioxide is at least partially removed (desorbed) from the liquid to recover the amine solution that can then be returned to the “loading” part of the circuit. In this way, the amine solution is sequentially loaded and unloaded as it transits around the circuit. The concentrated carbon dioxide is continuously removed from the circuit for disposal or other use.

The carbon dioxide contained in the loaded solution can appear in two forms: (1) as a dissolved gas, and (2) as a carbamate, which is a chemical combination of the amine and CO2. The formation of the carbamate is a reversible reaction where increased temperature favors the reverse reaction, that is, the formation of carbon dioxide.

Desorption, occurring during the stripping part of the circuit, involves the application of heat, which drives the decomposition of the carbamate to form carbon dioxide gas. The generation of this heat is energy intensive and can itself be a source of carbon dioxide emission. Further, amine agents, although effective, are subject to thermal degradation, especially if the temperatures used in the desorption process are excessively high.

Microwave energy can be effectively used as a heat source in the desorption process where the benefits include a much more rapid heating rate, increased carbon dioxide desorption rate, and more complete carbon dioxide desorption. Solutions for applying microwave energy to liquids are described in, for example: U.S. Pat. Nos. 4,401,873; 6,917,022; and 8,974,743; and International Patent Application Publication Numbers WO90/03840 and WO2020/254830. Ultrasonic energy can also be used as a source of energy for the removal of dissolved gas, as disclosed, for example, in European Patent Number EP 2276551 discloses the use of ultrasonics in such an application.

However, there remains a need for methods and systems that can more efficiently facilitate the transfer of energy to a liquid.

### SUMMARY

According to a first example aspect, a method of treating a liquid material within a treatment zone is disclosed. The liquid material includes solute material and liquid solvent material, the solute material being dissolved within the liquid solvent material, the solute material including a precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material. The method includes: applying a microwave field to the treatment zone; and applying an ultrasonic field to the treatment zone The applying of the microwave field and the applying of the ultrasonic field co-operate with effect that: the precursor material is converted to at least the target material-comprising material, such that a first intermediate fluid composition is obtained and includes the gaseous target material dissolved within the liquid solvent material; and cavitation bubbles are produced and the gaseous target material becomes emplaced within the cavitation bubbles, such that a second intermediate fluid composition is obtained and includes a liquid phase and a gaseous phase, wherein the gaseous phase includes the gaseous target material disposed within the produced cavitation bubbles. The gaseous target material is separated from the second intermediate fluid composition.

According to a second example aspect, a method of treating a liquid material is disclosed. The liquid material includes solute material and liquid solvent material, the solute material being dissolved within the liquid solvent material, the solute material including precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material. The method includes: converting the precursor material to at least the target material-comprising material, such that a first intermediate fluid composition is obtained and includes the gaseous target material dissolved within the liquid solvent material, wherein the converting includes converting that is stimulated in response to exposing the liquid material to a microwave field; degassing the first intermediate fluid composition such that a second intermediate fluid composition is obtained and includes a liquid phase and a gaseous phase, wherein the degassing includes exposing the first intermediate fluid composition to an ultrasonic field with effect that cavitation bubbles are produced and the gaseous target material becomes emplaced within the cavitation bubbles, such that the gaseous phase of the second intermediate fluid composition includes the gaseous target material-containing cavitation bubbles; and separating the gaseous target material from the second intermediate fluid composition.

According to a third example aspect, a method of treating a liquid material including dissolved gaseous material, is disclosed. The method includes: degassing the liquid material such that a first degassed intermediate fluid composition is obtained and includes a liquid phase and a gaseous phase, wherein the degassing includes exposing the liquid material to a first stage degassing-stimulating ultrasonic field with effect that first stage cavitation bubbles are produced, such that the gaseous phase includes the produced first stage cavitation bubbles; separating at least a fraction of the gaseous phase from the first degassed intermediate fluid composition with effect that: (i) a separated gaseous fraction is recovered, and (ii) a depleted intermediate fluid composition is obtained; and degassing the depleted intermediate fluid composition such that a second degassed intermediate fluid composition is obtained and includes a liquid phase and a gaseous phase, wherein the degassing includes exposing the depleted intermediate fluid composition to a second stage degassing-stimulating ultrasonic field with effect that second stage cavitation bubbles are produced, such that the gaseous phase includes the produced second stage cavitation bubbles.

According to a fourth example aspect, a method of treating a fluid composition is disclosed, wherein the fluid composition includes a liquid phase and a gaseous phase, the method comprising: separating at least a fraction of the gaseous phase from the fluid composition with effect that: (i) a separated gaseous fraction is recovered, and (ii) a gas-depleted fluid composition is obtained; and converting at least a fraction of the gas-depleted fluid composition, wherein the converting includes converting that is stimulated in response to exposing the gas-depleted fluid composition to a microwave field.

According to a fifth example aspect, a method of treating a liquid material is disclosed wherein the liquid material includes solute material and liquid solvent material, the solute material being dissolved within the liquid solvent material, the solute material including precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material. The method comprises: at a first temperature, converting a fraction of the precursor material to at least the target material-comprising material, such that a first intermediate fluid composition is obtained and includes a first intermediate fluid composition-defined solution, wherein the first intermediate fluid composition-defined solution includes solute material and liquid solvent material, the solute material being dissolved within the liquid solvent material, the solute material including the gaseous target material and residual precursor material, wherein the converting includes converting that is stimulated in response to exposing the liquid material to a first stage conversion-stimulating microwave field; degassing the first intermediate fluid composition such that a second intermediate fluid composition is obtained and includes a liquid phase and a gaseous phase, wherein the liquid phase includes the dissolved residual precursor material; and separating at least a fraction of the gaseous phase from the second intermediate fluid composition with effect that: (i) a separated gaseous fraction is recovered and includes the gaseous target material, and (ii) a gas-depleted second intermediate fluid composition is obtained. The degassing and the separating co-operate such that the gas-depleted second intermediate fluid composition includes the dissolved residual precursor material. The method also includes, a second temperature, converting at least a fraction of the residual precursor material to at least the target material-comprising material, wherein the converting includes converting that is stimulated in response to exposing the gas-depleted second intermediate fluid composition to a second stage conversion-stimulating microwave field. The second temperature exceeds the first temperature.

According to a sixth example aspect, a method of treating a liquid material is disclosed, wherein the liquid material includes solute material and liquid solvent material, the solute material being dissolved within the liquid solvent material, the solute material including a precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material. The method includes emplacing the liquid material within a first treatment zone, and at a first temperature within the first treatment zone, applying a first stage microwave field and applying a first stage ultrasonic field. The applying of the first stage microwave field and the applying of the first stage ultrasonic field co-operate with effect that: a fraction of the precursor material is converted to at least the target material-comprising material, such that a first intermediate fluid composition is obtained and includes a first intermediate fluid composition-defined solution, wherein the first intermediate fluid composition-defined solution includes solute material and liquid solvent material, the solute material being dissolved within the liquid solvent material, the solute material including the gaseous target material and residual precursor material, and such that converting of the precursor material to at least the target material-comprising material is effected; and first stage cavitation bubbles are produced and the gaseous target material becomes emplaced within the first stage cavitation bubbles, such that a second intermediate fluid composition is obtained and includes a liquid phase and a gaseous phase, wherein the gaseous phase includes the gaseous target material disposed within the produced first stage cavitation bubbles, and such that a first stage degassing of the gaseous target material is effected. The method also includes separating at least a fraction of the gaseous phase from the second intermediate fluid composition with effect that: (i) a separated gaseous fraction is recovered and includes the gaseous target material, and (ii) a gas-depleted second intermediate fluid composition is obtained, wherein: the first stage degassing and the separating co-operate such that the gas-depleted second intermediate fluid composition includes the dissolved residual precursor material. The method also includes emplacing the gas-depleted second intermediate fluid composition within a second treatment zone, and, at a second temperature within the second treatment zone, applying a second stage microwave field and applying a second stage ultrasonic field. The applying of the second stage microwave field and the applying of the second stage ultrasonic field co-operate with effect that: at least a fraction of the residual precursor material is converted to at least the target material-comprising material, such that a third intermediate fluid composition is obtained and includes the gaseous target material dissolved within the liquid solvent material, and such that converting of the residual precursor material to at least the target material-comprising material is effected; and second stage cavitation bubbles are produced and the gaseous target material becomes emplaced within the second stage cavitation bubbles, such that a fourth intermediate fluid composition is obtained and includes a liquid phase and a gaseous phase, wherein the gaseous phase includes the gaseous target material disposed within the produced second stage cavitation bubbles, and such that a second stage degassing of the gaseous target material is effected. The method also includes separating the gaseous target material from the fourth intermediate fluid composition. The second temperature exceeds the first temperature.

In at least some of the above example aspects, the treatment zone comprises a first enclosed fluid conducting path section located within a second waveguide conduit, the second waveguide conduit being coupled to a first waveguide conduit so as to enable microwave energy in the first waveguide conduit to pass into the second waveguide conduit. Applying the microwave field to the treatment zone comprises applying the microwave field to the first waveguide conduit such that at least some of the microwave field enters the second waveguide conduit to heat the liquid material contained within the first enclosed fluid conducting path section. A applying the ultrasonic field to the treatment zone comprises applying the ultrasonic field to the liquid material contained within the first enclosed fluid conducting path section using an ultrasonic transducer positioned within the first enclosed fluid conducting path section.

A liquid treatment unit is disclosed, that may for example be used to implement the methods of the preceding aspects.

According to a further example aspect, a liquid treatment unit is disclosed that includes a treatment zone into which a liquid material can be emplaced; a microwave energy waveguide structure; and an ultrasonic transducer. The treatment zone, the microwave energy waveguide structure and the ultrasonic transducer are cooperatively configured such that the microwave energy waveguide structure and the ultrasonic transducer collectively apply microwave energy and ultrasonic energy to the treatment zone to effect release of a gaseous material from the liquid material.

### BRIEF DESCRIPTION OF DRAWINGS

Reference will now be made, by way of example, to the accompanying drawings which show example implementations of the present application, and in which:

FIG. 1 is a process flow diagram of an embodiment of the present disclosure;

FIG. 2 is a process flow diagram of another embodiment of the present disclosure;

FIG. 3 illustrates, for comparison purposes, a schematic drawing of a microwave energy based fluid heating structure in a common arrangement of a tube mounted longitudinally along the central axis of a waveguide;

FIG. 4 illustrates schematic drawing of a microwave energy based fluid heating structure in an arrangement wherein a tube is mounted in a secondary waveguide that is coupled to a main waveguide;

FIG. 5 is a plot illustrating electric field distribution along tube axis for the arrangements of FIGS. 3 and 4; and

FIG. 6 is a schematic sectional view of a fluid treatment unit, according to aspects of the present disclosure.

### DETAILED DESCRIPTION

Methods, systems, and apparatus for treating a liquid material are provided. In some embodiments, for example, the liquid material is obtained from scrubbing a gaseous effluent with a scrubbing agent, wherein the gaseous effluent includes a target material. In some embodiments, for example, the scrubbing agent is an aqueous amine solution. Suitable amines include monoethanolamine. In some embodiments, for example, the target material is carbon dioxide.

The scrubbing operation can include bringing the gaseous effluent into contact with the solvent solution (e.g. aqueous amine solution) as, for example, by bubbling the gaseous effluent through the liquid. This may be accomplished as, for example, by injecting the gaseous effluent into the liquid by means of sparging nozzles which are designed to produce a high bubble density comprising very small bubbles, thereby increasing the bubble surface area thereby increasing the reaction rate between the gaseous effluent and the solvent solution. The scrubbing operation may also be commonly carried out by causing the liquid solvent solution to fall downward through a counterflowing (upward) gaseous effluent stream, thus creating close contact between the liquid solvent and the gaseous effluent.

The liquid material includes solute material and liquid solvent material. The solute material is dissolved within the liquid solvent material.

In those embodiments where the liquid material is obtained from scrubbing of carbon dioxide from a gaseous effluent with an aqueous amine solution, in some of these embodiments, for example, the liquid solvent material includes water.

The solute material includes a precursor material. The precursor material is ionic material that is soluble within the liquid solvent material.

In those embodiments where the liquid material is obtained from the scrubbing of a gaseous effluent with a scrubbing agent, in some of these embodiments, for example, the precursor material is derived from the target material. In those embodiments where the precursor material is derived from the target material, in some of these embodiments, for example, the scrubbing is with effect that at least the target material is converted (such as via a reactive process) to the precursor material. In those embodiments where the liquid material is obtained from scrubbing of carbon dioxide from a gaseous effluent with an aqueous amine solution, in some of these embodiments, for example, the precursor material includes a carbamate.

The precursor material is convertible into target material-comprising material in response to supplying of heat energy to the liquid material. The target material-comprising material is gaseous material that includes the target material. The target material is soluble within the liquid solvent material. In those embodiments where the liquid material is obtained from scrubbing carbon dioxide from a gaseous effluent with an aqueous amine solution, in some of these embodiments, for example, the target material is carbon dioxide.

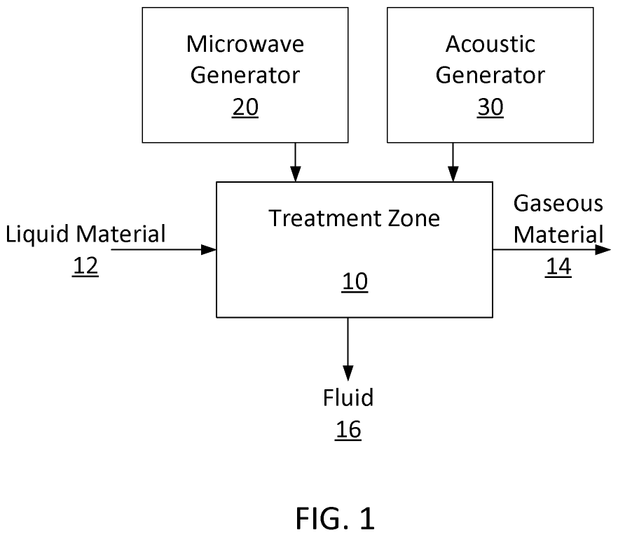

Referring to FIG. 1, in some embodiments, for example, the treating of the liquid material is effected within a treatment zone 10. The liquid material 12 is emplaced within the treatment zone 10, such as, for example, by being supplied to the treatment zone 10. The treating includes applying a microwave field to the treatment zone and applying an ultrasonic field to the treatment zone. Each one of the applying of a microwave field to the treatment zone and the applying of an ultrasonic field to the treatment zone, independently, is with effect that energy is supplied to the treatment zone.

The microwave field is generated by a microwave generator 20. In some embodiments, for example, suitable microwave frequencies are from 850 MHz to 928 MHz and also from 2400 MHz to 2500 MHz.

The ultrasonic field is generated by an acoustic generator 30. In some embodiments, for example, suitable ultrasonic frequencies are from 20 kHz to 30 kHz.

In example embodiments, the applying of the microwave field and the applying of the ultrasonic field co-operate with effect that: the precursor material is converted to at least the target material-comprising material, such that a first intermediate fluid composition is obtained and includes the gaseous target material dissolved within the liquid solvent material; and cavitation bubbles are produced and the gaseous target material becomes emplaced within the cavitation bubbles, such that a second intermediate fluid composition is obtained and includes a liquid phase and a gaseous phase, wherein the gaseous phase includes the gaseous target material disposed within the produced cavitation bubbles.

In some embodiments, for example, the conversion of the precursor material to at least the target material-comprising material is effected via a reactive process.

In some embodiments, for example, the converting of the precursor material is with additional effect that the scrubbing agent is regenerated. In some of these embodiments, for example, the regenerated scrubbing agent is recycled such that the scrubbing of a gaseous effluent includes scrubbing the gaseous effluent with the regenerated scrubbing agent.

In some embodiments, for example, at least some of the converting of the precursor material to at least the target material-comprising material is effected in response to the applying of the microwave field. In some embodiments, for example, some of the converting of the precursor material to at least the target material-comprising material is effected in response to the applying of the ultrasonic field.

In some embodiments, for example, at least some of the production of the cavitation bubbles is effected in response to the applying of the ultrasonic field.

The gaseous target material is then separated from the second intermediate fluid composition, such that the gaseous target material 14 and a gas-depleted second intermediate fluid composition 16 are obtained. In some embodiments, for example, the separation is effected in response to at least buoyancy forces (for example, the separation is a gravity separation).

In some embodiments, for example, prior to the treatment, the liquid material is pre-heated to a sufficient temperature to facilitate the treating in the treatment zone 10. In some of these embodiments, for example, the heating includes microwave heating via a microwave field generated by a microwave generator.

In some embodiments, for example, the combined use of microwave and ultrasonic energy in the amine regeneration process reduces the energy requirements compared to conventional heating methods. In some embodiments, for example, the supplied ultrasonic energy is tuned so as to avoid, or at least minimize, generation of heat energy.

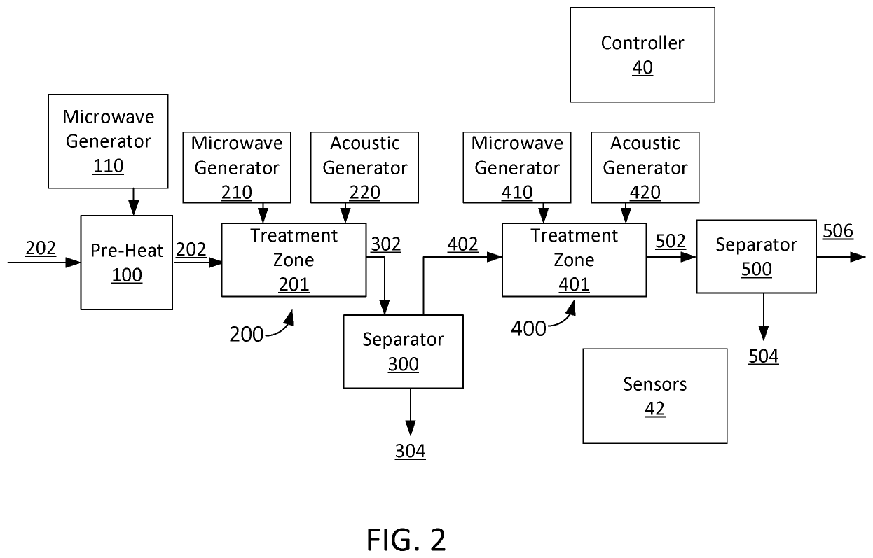

Referring to FIG. 2, in some embodiments, for example, the treating of the liquid material is effected in a multi-stage process.

In some embodiments, for example, the liquid material includes at least 30 mol % of precursor material, based on the total number of moles of the liquid material.

In this respect, in some embodiments, for example, the treating includes emplacing the liquid material 202 within (such as, for example, supplying to) a treatment zone 201 of a first unit operation 200. In some embodiments, for example, in order for the liquid material 202 to be disposed at a sufficient temperature for facilitating its treatment in the first unit operation, prior to emplacing the liquid material 202 within the first unit operation 200, the liquid material 202 is heated within a pre-heating unit operation 100. In some embodiments, for example, the heating includes microwave heating from microwave energy introduced by a microwave generator 110.

The treatment zone of the first unit operation 200 is disposed at a first temperature. While the liquid material 202 is emplaced within the treatment zone 201, a first stage microwave field is applied within the treatment zone 201, and a first stage ultrasonic field is applied to the treatment zone 201. Each one of the applying of a first stage microwave field to the treatment zone 201 and the applying of a first stage ultrasonic field to the treatment zone 201, independently, is with effect that energy is supplied to the treatment zone 201. The first stage microwave field is generated by a microwave field generator 210. The first stage ultrasonic field is generated by an ultrasonic field generator 220.

In example embodiments, the applying of the first stage microwave field and the applying of the first stage ultrasonic field can co-operate with effect that: a fraction of the precursor material is converted (such as, for example, via a reactive process) to at least the target material-comprising material, such that a first intermediate fluid composition is obtained and includes a first intermediate fluid composition-defined solution, wherein the first intermediate fluid composition-defined solution includes solute material and liquid solvent material, the solute material being dissolved within the liquid solvent material, the solute material including the gaseous target material and residual precursor material (such as, for example, unconverted precursor material), and such that converting of the precursor material to at least the target material-comprising material is effected; and first stage cavitation bubbles are produced and the gaseous target material becomes emplaced within the first stage cavitation bubbles, such that a second intermediate fluid composition 302 is obtained and includes a liquid phase and a gaseous phase, wherein the gaseous phase includes the gaseous target material disposed within the produced first stage cavitation bubbles, and such that a first stage degassing of the gaseous target material is effected.

In some embodiments, for example, at least some of the converting of the precursor material to at least the target material-comprising material is effected in response to the applying of the first stage microwave field. In some embodiments, for example, some of the converting of the precursor material to at least the target material-comprising material is effected in response to the applying of the first stage ultrasonic field.

In some embodiments, for example, at least some of the production of the cavitation bubbles is effected in response to the applying of the first stage ultrasonic field.

In some embodiments, for example, the gaseous phase of the second intermediate fluid composition 302 defines at least 30 mol % of the second intermediate fluid composition 302, based on the total number moles of the second intermediate fluid composition 302.

The gaseous target material is then separated from the second intermediate fluid composition 302. In this respect, in some embodiments, for example, the second intermediate fluid composition is discharged from the first unit operation 200 and supplied to a second unit operation 300 (e.g., a separator), wherein, in the second unit operation 300, at least a fraction of the gaseous phase is separated from the second intermediate fluid composition with effect that: (i) a separated gaseous fraction 304 is recovered and includes the gaseous target material, and (ii) a gas-depleted second intermediate fluid composition 402 is obtained. In some embodiments, for example, the separation is effected in response to at least buoyancy forces (for example, the separation is a gravity separation).

The gas-depleted second intermediate fluid composition 402 includes the residual precursor material (dissolved within the liquid solvent material). In some embodiments, for example, the total number of moles of the residual precursor material within the gas-depleted second intermediate fluid composition is less than 60% of the total number of moles of precursor material within the liquid material.

In some embodiments, for example, the total number of moles of gaseous material of the gaseous phase of the gas-depleted second intermediate fluid composition is less than 50% of the total number of moles of gaseous material within the second intermediate fluid composition.

The gas-depleted second intermediate fluid composition 402 then becomes emplaced within a treatment zone 401 of a third unit operation 400. In some embodiments, for example, the gas-depleted second intermediate fluid composition 402 is discharged from the second unit operation 300 and supplied to the third unit operation 400.

The treatment zone 401 of the third unit operation 400 is disposed at a second temperature. The second temperature of the treatment zone 401 of the third unit operation 400 exceeds the first temperature of the treatment zone 201 of the first unit operation 200. In some embodiments, for example, the second temperature of the treatment zone 401 of the third unit operation 400 exceeds the first temperature of the treatment zone 201 of the first unit operation 200 by at least 10 (ten) degrees Celsius. This is to compensate for the reduction in driving force towards conversion of the precursor material, caused by the depletion of precursor material as between the first and third unit operations 200, 400.

While the liquid material is emplaced within the treatment zone 401 of the third unit operation 400, a second stage microwave field is applied within the treatment zone 401 of the third unit operation 400, and a second stage ultrasonic field is applied to the treatment zone 401 of the third unit operation 400. Each one of the applying of a second stage microwave field to the treatment zone 401 and the applying of a second stage ultrasonic field to the treatment zone 401, independently, is with effect that energy is supplied to the treatment zone 401. The second stage microwave field is generated by a microwave field generator 410. The second stage ultrasonic field is generated by an acoustic generator 420.

In example embodiments, the applying of the second stage microwave field and the applying of the second stage ultrasonic field co-operate with effect that: at least a fraction of the residual precursor material is converted (such as, for example, via a reactive process) to at least the target material-comprising material, such that a third intermediate fluid composition is obtained and includes the gaseous target material dissolved within the liquid solvent material, and such that converting of the residual precursor material to at least the target material-comprising material is effected; and second stage cavitation bubbles are produced and the gaseous target material becomes emplaced within the second stage cavitation bubbles, such that a fourth intermediate fluid composition 502 is obtained and includes a liquid phase and a gaseous phase, wherein the gaseous phase includes the gaseous target material disposed within the produced second stage cavitation bubbles, and such that a second stage degassing of the gaseous target material is effected.

In some embodiments, for example, at least some of the converting of the precursor material to at least the target material-comprising material is effected in response to the applying of the second stage microwave field. In some embodiments, for example, some of the converting of the precursor material to at least the target material-comprising material is effected in response to the applying of the second stage ultrasonic field.

In some embodiments, for example, at least some of the production of the cavitation bubbles is effected in response to the applying of the second stage ultrasonic field.

The gaseous target material is then separated from the fourth intermediate fluid composition 502. In this respect, in some embodiments, for example, the fourth intermediate fluid composition 502 is discharged from the third unit operation 400 and supplied to a fourth unit operation 500 (e.g., a separator), wherein, in the fourth unit operation 500, at least a fraction of the gaseous phase is separated from the fourth intermediate fluid composition 502 with effect that: (i) a separated gaseous fraction 504 is recovered and includes the gaseous target material, and (ii) a gas-depleted fourth intermediate fluid composition 506 is obtained. In some embodiments, for example, the separation is effected in response to at least buoyancy forces (for example, the separation is a gravity separation).

Although two stages are illustrated, it is understood that the treatment if the liquid material may be effectuated in more than two stages.

The recovery of the gaseous target material, from the liquid material, is, in some embodiments, effectuated in two or more stages, whereby the gaseous target material is released between stages, for, amongst other things, one or more of the following reasons:
(i) mitigate excessive pressurization, which could cause the target material to re-dissolve within the liquid material;
(ii) remove gaseous material which could interfere with efficient energy transfer from the applied microwave field; and
(iii) increase efficiency in the use of energy for the conversion of the precursor material by converting the precursor material over multiple stages, at incrementally higher temperatures, as opposed to conversion of the precursor material in a single stage at a high temperature.

In some embodiments, for example, for each one of: (i) the converting of a fraction of the precursor material, and (ii) the converting of at least a fraction of residual precursor material, independently, the converting is with additional effect that the scrubbing agent is regenerated, and the process is configured such that regenerated scrubbing agent is disposed within the gas-depleted fourth intermediate fluid composition. In some embodiments, for example, the regenerated scrubbing agent is recycled such that the scrubbing of a gaseous effluent includes scrubbing the gaseous effluent with the regenerated scrubbing agent. In this respect, in some embodiments, for example, the regenerated scrubbing agent is derived from the gas-depleted fourth intermediate fluid composition. In some embodiments, for example, the recycling of the regenerated scrubbing agent is effected by scrubbing the gaseous effluent with the gas-depleted fourth intermediate fluid composition.

In some embodiments, for example, for each one of the microwave generators 210, 410 and acoustic generators 220, 420, its respective operation is controlled by a respective controller 40, and such controller is responsive to various in-line flow, composition (e.g. pH), and temperature sensors 42 for attenuating the respective electromagnetic field being generated, with a view to optimize energy efficiency.

Based on the above description, it will be appreciated that combined use of both microwave and ultrasonic energy for the process of heating a fluid to effect degassing (for example, in a carbon dioxide stripping process) can offer the advantages of both energy sources in a complementary fashion resulting in higher stripping efficiency, reduced operating temperature and overall reduced energy requirements.

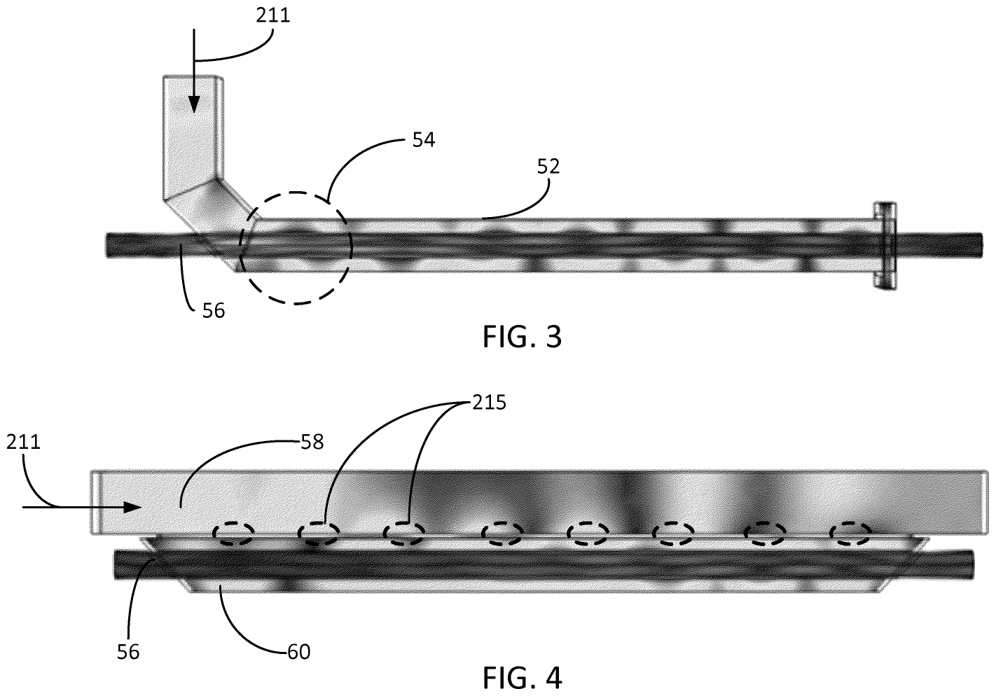

In this regard, an example embodiment of a fluid treatment unit 600 that can be used to implement, among other things, the process of FIG. 1, or the first unit operation 200 or the third unit operation 400 of the process of FIG. 2, will now be explained with reference to FIGS. 3 to 6.

According to example aspects of the present disclosure, a structure and method for usefully combining microwave and ultrasonic energy as a process for treating a liquid to effect separation of a gaseous target material from a liquid solvent material (for example, stripping gas from a loaded amine solution). Aspects of the present disclosure are also directed to addressing a microwave impedance mismatch which can be encountered in the use of a liquid-carrying conduit located within a waveguide or cavity being used as a means of heating a liquid as part of a gas stripping process.

According to an example aspect, a liquid material is subjected to energy sources for the purpose of effecting a chemical or physical change in the stream. The chemical or physical change may result from degassing of the stream. In one instance, the liquid stream may contain one or more dissolved gases which must be substantially removed. In another instance, the liquid may contain a chemical agent, such as an amine, which includes a chemically bonded gas such as carbon dioxide, wherein the purpose of the process is to substantially reduce the amount of gas in the liquid stream.

As described in greater detail below, fluid treatment unit 600 can enable an efficient combination of microwave energy with ultrasonic energy to effect the release of contained gas from the liquid stream in such a way that can, in some applications, substantially reduce the energy requirements, compared to conventional heating methods, and/or substantially improve the rate and extent of gas removal from said liquid stream.

By way of context, FIG. 3 illustrates an electric field distribution in a common arrangement of a liquid conducting tube 56 mounted longitudinally along the central axis of a waveguide 52. In the arrangement of FIG. 3, no ultrasonic energy is applied. By way of example, waveguide 52 can be a WR340 waveguide, and the tube 56 can be is 20 mm D×610 mm L. The waveguide 52 is terminated in a short circuit plate, giving rise to the evident standing wave. The most obvious field disturbance is at the region 54 where the electromagnetic wave first impinges on the tube 56, and this is largely unaffected by the energy absorption in the tube 56.

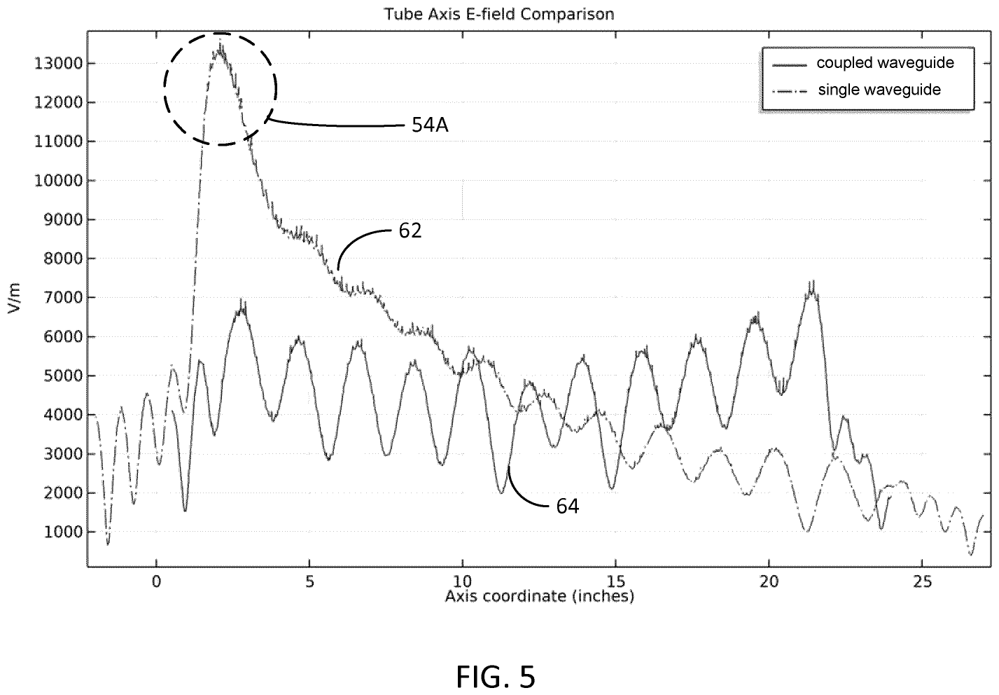

In contrast, FIG. 4 shows the field distribution where a tube 56 is mounted in a coupled waveguide 60 that is coupled to a main waveguide 58 such that microwave energy can pass from the main waveguide 58 to the couple waveguide through a plurality of axially spaced coupling apertures that function as microwave energy transmission elements 215. In this case, the main waveguide 58 is terminated in a matched (absorbing) load, which simulates the configuration where the tube 56 exits from the coupled waveguide and forms a cross-guide water load in the main waveguide 58. The electric field strength along the central axis of the tube 56 for both the coupled waveguide configuration of FIG. 4 and the single waveguide configuration is shown in FIG. 5 as plot lines 64 and 62, respectively. In addition to eliminating the large spike 54A in the electric field, which corresponds region 54 and presents an arc breakdown power limitation, the coupled waveguide configuration significantly reduces the electrical field strength over the entire length of the tube, which reduces deactivation of the amine agent.

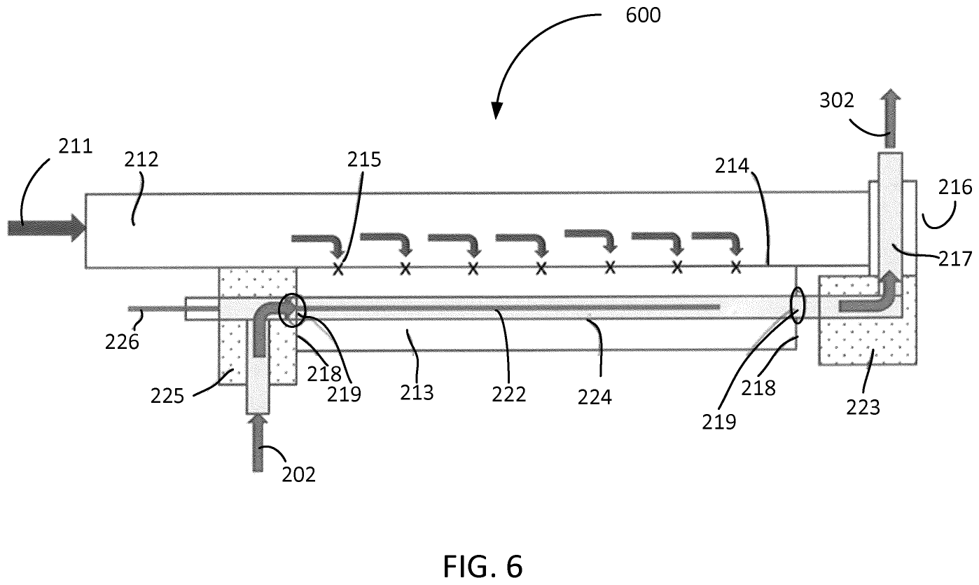

FIG. 6 illustrates an example of a fluid treatment unit 600 for use in a fluid treatment system, according to example aspects of the disclosure. Fluid treatment unit 600 is described below in the context of a unit that is being used to implement the first unit operation 200 of the treatment system of FIG. 2. A further fluid treatment unit 600 can be used to implement the third unit operation 400. The fluid treatment unit 600 can also be applied in other systems, including to implement solo treatment zone in a single-stage degassing process such as shown in FIG. 1, and in serial combinations of more than 2 units to implement systems that have more treatment zones than shown in FIG. 2.

In one embodiment, microwave energy 211 (which may for example be supplied by microwave generator such a microwave generator 210) enters a first waveguide conduit 212, to which is affixed a second waveguide conduit 213. First waveguide conduit 212 and second waveguide conduit 213 collectively from a microwave energy waveguide structure. In the illustrated example, the two waveguide conduits 212, 213 are rectangular waveguide conduits that are located adjacent and parallel to each other along their respective longitudinal axis. In the illustrated example, the first and second waveguide conduits 212, 213 are joined by a common conduit wall 214 in which is arranged one or more microwave energy transmission elements 215 (e.g., coupling apertures in the illustrated example) suitably designed to allow passage of at least a portion of the microwave energy in first waveguide conduit 212 into second waveguide conduit 213 thereby coupling the waveguide conduits. As is understood by one knowledgeable in waveguide physics, the aperture size and location of the microwave energy transmission elements may be selected so as to cause the individual energy contributions so entering second waveguide conduit to constructively combine.

The first waveguide conduit 212 is configured to include a termination 216, which may take the simple form of a dielectric liquid-carrying enclosed liquid flow path, for example a dielectric liquid-carrying tube 217 (or a structure that includes dielectric liquid-carrying tube 217) passing transversely through the first waveguide conduit 212. The dielectric tube 217 is composed of a suitable material, for example a material that is sufficiently or essentially transparent to microwave energy at the frequency being used, so that at least a portion of the microwave energy in first waveguide conduit 212 may be absorbed by the contained liquid.

The second waveguide conduit 213 is configured to include terminations 218 at its opposing ends, to the effect that said second waveguide conduit 213 forms a closed microwave cavity. Included within the second waveguide conduit 213 is an axially extending enclosed fluid path in the form of dielectric tube 224 which is formed from a material that is sufficiently or essentially transparent to microwave energy at the frequency being used, so that at least a portion of the microwave energy in second waveguide conduit 213 may be absorbed by the contained liquid. Notwithstanding the closed nature of the waveguide cavity provided by the second waveguide conduit 213, it is understood that there may be provided certain openings 219 to allow passage of fittings, tubes and the like, provided that appropriate fixtures are employed which will attenuate microwave leakage from the cavity.

In the illustrated example, the dielectric tube 224 located in the second waveguide conduit 213 and the dielectric tube 217 located at the first waveguide conduit termination 216 respectively provide a first enclosed fluid conducting path section and enclosed fluid conducting path section that together define a continuous fluid flow path and collectively form a treatment zone (for example treatment zone 201 in the case where fluid treatment unit 600 is used to implement first unit operation 200).

One end of the second waveguide conduit 213 is externally in communication with an assembly 225 through which liquid material 202 may flow into the dielectric tube 224. An ultrasonic transducer 222 extends axially within the dielectric tube 224. The assembly 225 is configured to enables an end 226 of the ultrasonic transducer 222 to extend externally from the dielectric tube 224 while also maintaining liquid containment. The end 226 of the ultrasonic transducer 222 can be connected to acoustic generator 220 to enable an ultrasonic field to be applied to liquid contained within the dielectric tube 224.

The opposing end of second waveguide conduit 213 is fitted with an assembly 223 which allows liquid to easily pass from the second waveguide conduit dielectric tube 224 into the dielectric liquid-carrying tube 217 that forms the first waveguide conduit termination 216.

In operation, microwave energy 211 is delivered to the first waveguide conduit 212 from microwave generator 210, which may for example include a magnetron or solid-state generator. As the microwave energy 211 propagates along the first waveguide conduit 212, at least a portion of the energy passes into the second waveguide conduit 213 and is absorbed in the liquid contained in second waveguide conduit dielectric tube 224. Any remaining microwave energy passes into the termination load at the end of the first waveguide conduit 212 (e.g., the dielectric liquid-carrying tube 217 of termination 216 and can be absorbed by the liquid passing therethrough. Additionally, ultrasonic transducer 222 delivers ultrasonic energy directly to the inside of the dielectric tube 224. The combined microwave and ultrasonic energy acts on the input liquid material 202 to obtain the fluid composition 302.

In a further example embodiment, the direction of liquid flow may be reversed so as to first pass the liquid material 202 through the termination load (e.g., the dielectric liquid-carrying tube 217 of termination 216) and then through the second waveguide conduit dielectric tube 224, such that the fluid composition 302 exits through assembly 225. In this configuration, the liquid is first at least partially heated before being subjected to the combined ultrasonic and microwave effects within the dielectric tube 224. In some scenarios, this can directly improve the ultrasonic effect in the removal of desorbed gas without wasting ultrasonic energy as a direct heating mechanism.

As will be understood, the amount of energy absorbed separately by the liquid in each of the second waveguide conduit dielectric tube 224 and the termination dielectric tube 217 is dependent upon the size and placement of the dielectric members located therein. For example, increasing the length of the second waveguide conduit 213 as well as its contained dielectric tube 224 will increase the amount of energy absorbed therein. In a similar fashion, changing the placement and size of the dielectric tube 217 within the first waveguide conduit termination 216 will affect the amount of energy absorbed therein.

In a test implementation, WR340 waveguide was used for the waveguide conduits 212, 213, with microwave energy 211 at a frequency of 2450 MHz. The second waveguide conduit 213 contained The dielectric tube 224 contained in second waveguide conduit 213 was 0.6 m long and 20 mm in diameter and centrally located along the cavity axis. Water was used as the liquid load. Seventy percent of the microwave power was absorbed in the tube and the remaining 30% was absorbed in the terminating load.

In example embodiments, liquid treatment unit 600 can be specifically configured to perform a specific process, such configuration including selecting design parameters with an objective of matching the energy absorption capacities to produce a required temperature effect within the liquid at a prescribed liquid flow rate.

One or more system configuration attributes and operational properties, including the following, can be determined to achieve a desired performance: microwave frequencies (e.g., 2450 MHz or 915 MHz); ultrasonic frequencies (e.g., 10 to 20 kHz); process temperature ranges; power absorption ratios (load/coupled guide); pressure ranges (limited by dielectric tube strength); dielectric tube materials; monitoring/control mechanisms (e.g., controller 40, sensors 42)

In different example embodiments, different coupling configurations other than a common wall 214 with coupling apertures can be used to couple the first waveguide conduit 212 and second waveguide conduit 213. For example, first waveguide conduit 212 and second waveguide conduit 213 could be discrete waveguide conduits spaced apart from each other and joined by a plurality of microwave transmission elements that each include a coaxial conductor having a first antenna probe at one end extending into the first waveguide conduit 212 and a second antenna probe at the opposite end extending into the second waveguide conduit 213 to allow passage of at least a portion of the microwave energy in first waveguide conduit 212 into second waveguide conduit 213. Further, waveguide structures other than rectangular conduit waveguides can be employed; for example cylindrical waveguide conduits can be coupled together to implement a fluid treatment unit.

As used herein, the terms, “comprises” and “comprising” are to be construed as being inclusive and open ended, and not exclusive. Specifically, when used in the specification and claims, the terms, “comprises” and “comprising” and variations thereof mean the specified features, steps or components are included. These terms are not to be interpreted to exclude the presence of other features, steps or components.

As used herein, the term “exemplary” or “example” means “serving as an example, instance, or illustration,” and should not be construed as preferred or advantageous over other configurations disclosed herein.

As used herein, the terms “about”, “approximately”, and “substantially” are meant to cover variations that may exist in the upper and lower limits of the ranges of values, such as variations in properties, parameters, and dimensions.

As used herein, statements that a second item (e.g., a signal, value, scalar, vector, matrix, calculation, or bit sequence) is “based on” a first item can mean that characteristics of the second item are affected or determined at least in part by characteristics of the first item. The first item can be considered an input to an operation or calculation, or a series of operations or calculations that produces the second item as an output that is not independent from the first item.

Although the present disclosure describes methods and processes with steps in a certain order, one or more steps of the methods and processes can be omitted or altered as appropriate. One or more steps can take place in an order other than that in which they are described, as appropriate.

The present disclosure can be embodied in other specific forms without departing from the subject matter of the claims. The described example implementations are to be considered in all respects as being only illustrative and not restrictive. Selected features from one or more of the above-described implementations can be combined to create alternative implementations not explicitly described, features suitable for such combinations being understood within the scope of this disclosure.

All values and sub-ranges within disclosed ranges are also disclosed. Also, although the systems, devices and processes disclosed and shown herein can include a specific number of elements/components, the systems, devices and assemblies could be modified to include additional or fewer of such elements/components. For example, although any of the elements/components disclosed can be referenced as being singular, the implementations disclosed herein could be modified to include a plurality of such elements/components. The subject matter described herein intends to cover and embrace all suitable changes in technology.

What is claimed is:

1. A method of treating a liquid material within a treatment zone, wherein the liquid material includes solute material and liquid solvent material, the solute material being dissolved within the liquid solvent material, the solute material including a precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material, comprising:
applying a microwave field to the treatment zone;
applying an ultrasonic field to the treatment zone;
wherein:
the applying of the microwave field and the applying of the ultrasonic field co-operate with effect that:
(i) the precursor material is converted to at least the target material-comprising material, such that a first intermediate fluid composition is obtained and includes the gaseous target material dissolved within the liquid solvent material; and
(ii) cavitation bubbles are produced and the gaseous target material becomes emplaced within the cavitation bubbles, such that a second intermediate fluid composition is obtained and includes a liquid phase and a gaseous phase, wherein the gaseous phase includes the gaseous target material disposed within the produced cavitation bubbles; and
separating the gaseous target material from the second intermediate fluid composition.

2. A method of treating a liquid material, wherein the liquid material includes solute material and liquid solvent material, the solute material being dissolved within the liquid solvent material, the solute material including precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material, comprising:
converting the precursor material to at least the target material-comprising material, such that a first intermediate fluid composition is obtained and includes the gaseous target material dissolved within the liquid solvent material, wherein the converting includes converting that is stimulated in response to exposing the liquid material to a microwave field;
degassing the first intermediate fluid composition such that a second intermediate fluid composition is obtained and includes a liquid phase and a gaseous phase, wherein the degassing includes exposing the first intermediate fluid composition to an ultrasonic field with effect that cavitation bubbles are produced and the gaseous target material becomes emplaced within the cavitation bubbles, such that the gaseous phase of the second intermediate fluid composition includes the gaseous target material-containing cavitation bubbles; and
separating the gaseous target material from the second intermediate fluid composition.

3. A method of treating a liquid material including dissolved gaseous material, comprising:
degassing the liquid material such that a first degassed intermediate fluid composition is obtained and includes a liquid phase and a gaseous phase, wherein the degassing includes exposing the liquid material to a first stage degassing-stimulating ultrasonic field with effect that first stage cavitation bubbles are produced, such that the gaseous phase includes the produced first stage cavitation bubbles;
separating at least a fraction of the gaseous phase from the first degassed intermediate fluid composition with effect that: (i) a separated gaseous fraction is recovered, and (ii) a depleted intermediate fluid composition is obtained; and
degassing the depleted intermediate fluid composition such that a second degassed intermediate fluid composition is obtained and includes a liquid phase and a gaseous phase, wherein the degassing includes exposing the depleted intermediate fluid composition to a second stage degassing-stimulating ultrasonic field with effect that second stage cavitation bubbles are produced, such that the gaseous phase includes the produced second stage cavitation bubbles.

4. A method of treating a fluid composition, wherein the fluid composition includes a liquid phase and a gaseous phase, comprising:
separating at least a fraction of the gaseous phase from the fluid composition with effect that: (i) a separated gaseous fraction is recovered, and (ii) a gas-depleted fluid composition is obtained; and
converting at least a fraction of the gas-depleted fluid composition, wherein the converting includes converting that is stimulated in response to exposing the gas-depleted fluid composition to a microwave field.

5. The method as claimed in claim 4, further comprising:
prior to the separating, degassing a pre-cursor fluid composition such that the fluid composition is obtained and includes a liquid phase and a gaseous phase, wherein the degassing includes exposing the pre-cursor fluid composition to an ultrasonic field with effect that cavitation bubbles are produced, such that the gaseous phase of the second intermediate fluid composition includes the cavitation bubbles.

6. A method of treating a liquid material, wherein the liquid material includes solute material and liquid solvent material, the solute material being dissolved within the liquid solvent material, the solute material including precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material, comprising:
at a first temperature, converting a fraction of the precursor material to at least the target material-comprising material, such that a first intermediate fluid composition is obtained and includes a first intermediate fluid composition-defined solution, wherein the first intermediate fluid composition-defined solution includes solute material and liquid solvent material, the solute material being dissolved within the liquid solvent material, the solute material including the gaseous target material and residual precursor material, wherein the converting includes converting that is stimulated in response to exposing the liquid material to a first stage conversion-stimulating microwave field;
degassing the first intermediate fluid composition such that a second intermediate fluid composition is obtained and includes a liquid phase and a gaseous phase, wherein the liquid phase includes the dissolved residual precursor material;
separating at least a fraction of the gaseous phase from the second intermediate fluid composition with effect that: (i) a separated gaseous fraction is recovered and includes the gaseous target material, and (ii) a gas-depleted second intermediate fluid composition is obtained;
wherein:
the degassing and the separating co-operate such that the gas-depleted second intermediate fluid composition includes the dissolved residual precursor material; and
at a second temperature, converting at least a fraction of the residual precursor material to at least the target material-comprising material, wherein the converting includes converting that is stimulated in response to exposing the gas-depleted second intermediate fluid composition to a second stage conversion-stimulating microwave field;
wherein:
the second temperature exceeds the first temperature.

7. A method of treating a liquid material, wherein the liquid material includes solute material and liquid solvent material, the solute material being dissolved within the liquid solvent material, the solute material including a precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material, comprising:
emplacing the liquid material within a first treatment zone;
at a first temperature within the first treatment zone,
applying a first stage microwave field;
applying a first stage ultrasonic field;
wherein:
the applying of the first stage microwave field and the applying of the first stage ultrasonic field co-operate with effect that:
(i) a fraction of the precursor material is converted to at least the target material-comprising material, such that a first intermediate fluid composition is obtained and includes a first intermediate fluid composition-defined solution, wherein the first intermediate fluid composition-defined solution includes solute material and liquid solvent material, the solute material being dissolved within the liquid solvent material, the solute material including the gaseous target material and residual precursor material, and such that converting of the precursor material to at least the target material-comprising material is effected; and
(ii) first stage cavitation bubbles are produced and the gaseous target material becomes emplaced within the first stage cavitation bubbles, such that a second intermediate fluid composition is obtained and includes a liquid phase and a gaseous phase, wherein the gaseous phase includes the gaseous target material disposed within the produced first stage cavitation bubbles, and such that a first stage degassing of the gaseous target material is effected;
separating at least a fraction of the gaseous phase from the second intermediate fluid composition with effect that: (i) a separated gaseous fraction is recovered and includes the gaseous target material, and (ii) a gas-depleted second intermediate fluid composition is obtained;
wherein:
the first stage degassing and the separating co-operate such that the gas-depleted second intermediate fluid composition includes the dissolved residual precursor material;
emplacing the gas-depleted second intermediate fluid composition within a second treatment zone;
at a second temperature within the second treatment zone,
applying a second stage microwave field;
applying a second stage ultrasonic field;
wherein:
the applying of the second stage microwave field and the applying of the second stage ultrasonic field co-operate with effect that:
(i) at least a fraction of the residual precursor material is converted to at least the target material-comprising material, such that a third intermediate fluid composition is obtained and includes the gaseous target material dissolved within the liquid solvent material, and such that converting of the residual precursor material to at least the target material-comprising material is effected; and
(ii) second stage cavitation bubbles are produced and the gaseous target material becomes emplaced within the second stage cavitation bubbles, such that a fourth intermediate fluid composition is obtained and includes a liquid phase and a gaseous phase, wherein the gaseous phase includes the gaseous target material disposed within the produced second stage cavitation bubbles, and such that a second stage degassing of the gaseous target material is effected; and
separating the gaseous target material from the fourth intermediate fluid composition;
wherein:
the second temperature exceeds the first temperature.

8. The method as claimed in claim 7;
further comprising:
prior to the emplacing of the liquid material within the first treatment zone, scrubbing a gaseous effluent with a scrubbing agent, with effect that the liquid material is obtained;
wherein:
the gaseous effluent includes the target material; and
the scrubbing is with effect that at least the target material is converted to the precursor material.

9. The method as claimed in claim 8;
wherein:
for each one of: (i) the converting of a fraction of the precursor material, and (ii) the converting of at least a fraction of residual precursor material, independently, is with additional effect that the scrubbing agent is regenerated.

10. The method as claimed in claim 9;
wherein:
the regenerated scrubbing agent is recycled such that the scrubbing of a gaseous effluent includes scrubbing the gaseous effluent with the regenerated scrubbing agent.

11. The method as claimed in any one of claims 1, 2, 6 and 7 to 10;
wherein:
the precursor material includes a carbamate;
the target material includes carbon dioxide;
the liquid solvent material includes water.

12. The method as claimed in any one of claims 8 to 10;
wherein:
the scrubbing agent includes an amine.

13. The method as claimed in claim 7;
wherein:
the precursor material includes a carbamate;
the target material includes carbon dioxide;
the liquid solvent material includes water.

14. The method as claimed in any one of claims 7 to 13;
wherein:
for each one of: (i) the conversion of a fraction of the precursor material, and (ii) the conversion of at least a fraction of the residual precursor material, independently, the conversion is effected via a reactive process.

15. The method as claimed in any one of claims 7 to 14;
wherein:
for each one of: (i) the separating of at least a fraction of the gaseous phase from the second intermediate fluid composition, and (ii) the separating of the gaseous target material from the fourth intermediate fluid composition, independently, the separating is effected in response to at least buoyancy forces.

16. The method as claimed in any one of claims 7 to 15;
wherein:
at least some of the converting of the precursor material to at least the target material-comprising material is effected in response to the applying of a first stage microwave field; and
at least some of the converting of the residual precursor material to at least the target material-comprising material is effected in response to the applying of a second stage microwave field.

17. The method as claimed in claim 16;
wherein:
some of the converting of the precursor material to at least the target material-comprising material is effected in response to the applying of a first stage ultrasonic field; and
some of the converting of the residual precursor material to at least the target material-comprising material is effected in response to the applying of a second stage ultrasonic field.

18. The method as claimed in any one of claims 7 to 17;
wherein:
at least some of the first stage degassing is effected in response to the applying of a first stage ultrasonic field; and
at least some of the second stage degassing is effected in response to the applying of a second stage ultrasonic field.

19. The method as claimed in any one of claims 7 to 18;
wherein:
the liquid material includes at least 30 mol % of precursor material, based on the total number of moles of the liquid material.

20. The method as claimed in any one of claims 7 to 19;
wherein:
the total number of moles of the residual precursor material within the gas-depleted second intermediate fluid composition is less than 60% of the total number of moles of precursor material within the liquid material.

21. The method as claimed in any one of claims 7 to 20;
wherein:
the gaseous phase of the second intermediate fluid composition defines at least 30 mol % of the second intermediate fluid composition, based on the total number moles of the second intermediate fluid composition.

22. The method as claimed in any one of claims 7 to 21;
wherein:
the total number of moles of gaseous material of the gaseous phase of the gas-depleted second intermediate fluid composition is less than 50% of the total number of moles of gaseous material within the second intermediate fluid composition.

23. The method as claimed in any one of claims 7 to 22;
wherein:
the second temperature exceeds the first temperature by at least 10 (ten) degrees Celsius.

24. The method of claim 1 wherein the treatment zone comprises a first enclosed fluid conducting path section located within a second waveguide conduit, the second waveguide conduit being coupled to a first waveguide conduit so as to enable microwave energy in the first waveguide conduit to pass into the second waveguide conduit, and
wherein applying the microwave field to the treatment zone comprises applying the microwave field to the first waveguide conduit such that at least some of the microwave field enters the second waveguide conduit to heat the liquid material contained within the first enclosed fluid conducting path section; and
wherein applying the ultrasonic field to the treatment zone comprises applying the ultrasonic field to the liquid material contained within the first enclosed fluid conducting path section using an ultrasonic transducer positioned within the first enclosed fluid conducting path section.

25. The method of claim 24 wherein the treatment zone comprises a second enclosed fluid conducting path section in fluid communication with the first enclosed fluid conducting path section, the second enclosed fluid conducting path section being located at a termination of the first waveguide conduit, wherein applying the microwave field to the treatment zone further comprises applying the microwave field such that at least some of the microwave field heats the liquid material contained within the second enclosed fluid conducting path section.

26. The method of claim 25 comprising emplacing the liquid material within the treatment zone such that the liquid material first passes through the first enclosed fluid conducting path section followed by the second enclosed fluid conducting path section.

27. The method of claim 25 comprising emplacing the liquid material within 10 the treatment zone such that the liquid material first passes through the second enclosed fluid conducting path section followed by the first enclosed fluid conducting path section.

28. The method of any one of claims 7 to 10 and 12 to 23 wherein:
the first treatment zone comprises a first stage first enclosed fluid conducting path section located within a first stage second waveguide conduit, the first stage second waveguide conduit being coupled to a first stage first waveguide conduit so as to enable microwave energy in the first stage first waveguide conduit to pass into the first stage second waveguide conduit, and
wherein applying the first stage microwave field comprises applying the first stage microwave field to the first stage first waveguide conduit such that at least some of the first stage microwave field enters the first stage second waveguide conduit to heat the liquid material emplaced within the first stage first enclosed fluid conducting path section; and
wherein applying the first stage ultrasonic field comprises applying the ultrasonic field to the liquid material emplaced within the first stage first enclosed fluid conducting path section using an ultrasonic transducer positioned within the first stage first enclosed fluid conducting path section; and
the second treatment zone comprises a second stage first enclosed fluid conducting path section located within a second stage second waveguide conduit, the second stage second waveguide conduit being coupled to a second stage first waveguide conduit so as to enable microwave energy in the second stage first waveguide conduit to pass into the second stage second waveguide conduit, and
wherein applying the second stage microwave field comprises applying the second stage microwave field to the second stage first waveguide conduit such that at least some of the second stage microwave field enters the second stage second waveguide conduit to heat the second intermediate fluid composition emplaced within the second stage first enclosed fluid conducting path section; and
wherein applying the second stage ultrasonic field to the treatment zone comprises applying the ultrasonic field to the second intermediate fluid composition emplaced within the second stage first enclosed fluid conducting path section using an ultrasonic transducer positioned within the second stage first enclosed fluid conducting path section.

29. The method of claim 28 wherein the first stage treatment zone comprises a first stage second enclosed fluid conducting path section in fluid communication with the first stage first enclosed fluid conducting path section, the first stage second enclosed fluid conducting path section being located at a termination of the first stage first waveguide conduit, wherein applying the first stage microwave field further comprises applying the first stage microwave field such that at least some of the first stage microwave field heats the liquid material emplaced within the first stage second enclosed fluid conducting path section; and
the second stage treatment zone comprises a second stage second enclosed fluid conducting path section in fluid communication with the second stage first enclosed fluid conducting path section, the second stage second enclosed fluid conducting path section being located at a termination of the second stage first waveguide conduit, wherein applying the second stage microwave field further comprises applying the second stage microwave field such that at least some of the second stage microwave field heats the second intermediate fluid composition emplaced within the second stage second enclosed fluid conducting path section.

30. A liquid treatment unit comprising:
a treatment zone into which a liquid material can be emplaced;
a microwave energy waveguide structure; and
an ultrasonic transducer;
the treatment zone, the microwave energy waveguide structure and the ultrasonic transducer being cooperatively configured such that the microwave energy waveguide structure and the ultrasonic transducer collectively apply microwave energy and ultrasonic energy to the treatment zone to effect release of a gaseous material from the liquid material.

31. The liquid treatment unit of claim 30 wherein:
the microwave energy waveguide structure comprises a first waveguide conduit and a second waveguide conduit coupled such that at least a portion of microwave energy applied to the first waveguide conduit will be transmitted to the second waveguide conduit;
the treatment zone comprises a first enclosed fluid conducting path section located within the second waveguide conduit to receive at least a portion of microwave energy transmitted to the second waveguide from the first waveguide conduit;
the second waveguide conduit being coupled to a first waveguide conduit so as to enable microwave energy in the first waveguide conduit to pass into the second waveguide conduit, and
the ultrasonic transducer being positioned within the first enclosed fluid conducting path section to apply ultrasonic energy therein.

32. The liquid treatment unit of claim 31 wherein the first waveguide conduit and the second waveguide conduit are coupled such that the at least a portion of the microwave energy transmitted to the second waveguide conduit is evenly distributed along a length of the first enclosed fluid conducting path section within the second waveguide conduit.

33. The liquid treatment unit of claim 31 or 32 wherein the treatment zone comprises a second enclosed fluid conducting path section in fluid communication with the first enclosed fluid conducting path section, the second enclosed fluid conducting path section being located at a termination of the first waveguide conduit such that at least a further portion of the microwave energy applied to the first waveguide conduit is transferred to liquid material emplaced within the second enclosed fluid conducting path section.

34. The liquid treatment unit of any one of claims 31 to 33 wherein the first enclosed fluid conducting path section comprises a dielectric tube.

35. The liquid treatment unit of any one of claims 31 to 34 wherein the first waveguide conduit and the second waveguide conduit are each respective rectangular waveguide conduits arranged parallel to each other.

36. The liquid treatment unit of claim 35 wherein the first waveguide conduit and the second waveguide conduit share a common waveguide wall having a plurality of microwave transmitting apertures extending therethrough.

37. The liquid treatment unit of any one of claims 31 to 36 wherein the second waveguide conduit is configured to function as a closed microwave cavity.

38. The liquid treatment unit of any one of claims 30 to 37 wherein the treatment unit is configured to treat liquid material that includes solute material and liquid solvent material, the solute material being dissolved within the liquid solvent material, the solute material including a precursor material, the precursor material being ionic material that is soluble within the liquid solvent material and is convertible into target material-comprising material in response to supplying of heat energy to the liquid material, the target material-comprising material being gaseous material that includes target material, the target material being soluble within the liquid solvent material, and wherein
the treatment zone, the microwave energy waveguide structure and the ultrasonic transducer are cooperatively configured such that applying the microwave energy and the ultrasonic energy co-operate with effect that:
(i) the precursor material is converted to at least the target material-comprising material, such that a first intermediate fluid composition is obtained and includes the gaseous target material dissolved within the liquid solvent material; and
(ii) cavitation bubbles are produced and the gaseous target material becomes emplaced within the cavitation bubbles, such that a second intermediate fluid composition is obtained and includes a liquid phase and a gaseous phase, wherein the gaseous phase includes the gaseous target material disposed within the produced cavitation bubbles.

39. A liquid treatment system comprising a plurality of the liquid treatment units of anyone of claims 1 to 38 wherein the treatment zones are serially coupled as part of a fluid transmission path through the liquid treatment system, the liquid treatment system including at least one separator unit between adjacent liquid treatment units for separating a gas from the liquid material.
